(19) United States
(12) Patent Application Publication
(10) Pub. No.: US 2011/0091139 A1
(43) Pub. Date: Apr. 21, 2011

(54) COLLAPSIBLE LIQUID CONTAINER AND A METHOD FOR MAKING THEREOF

(76) Inventor: Alimi AHMED, Petach Tikva (IL)

(21) Appl. No.: 12/580,578

(22) Filed: Oct. 16, 2009

(51) Int. Cl. B65D 33/00; B31B 1/14

(52) U.S. Cl. 383/105; 493/227

(57) ABSTRACT

A collapsible liquid container and a method for making foldable liquid containers, the collapsible liquid container includes: a first sheet, comprising: a cover wedge portion that forms a collapsible cover of the collapsible liquid container; a bottom wedge portion that forms a collapsible bottom of the collapsible liquid container; and a sheet body that forms a first side wall of the collapsible liquid container; wherein the cover wedge portion and the bottom wedge portion are integral extensions of the sheet body; and a second sheet that forms a second side wall of the collapsible liquid container.

### FIELD OF THE INVENTION

The present invention relates to liquid containers, and more particularly, to liquid containers that can expand and collapse.

### BACKGROUND OF THE INVENTION

Liquid contents or gel type contents such as creams, sauce, beverages or detergents are contained in various types of packaging materials and are packed for marketing.

A general liquid filling container forms a predetermined space inside by sealing more than one side of a flexible film through heat deflection and heat adhesion methods, and interposes a discharge element between film surfaces of sealing portions.

Another type of liquid filling container has two sheets of films which edges thereof are sealed together, but it is not commonly used as drink container due to its poor stability and self supporting ability.

In order to overcome the problem of a poor self supporting ability, a foldable portion is formed in a lower part of the container for improving the self-supporting ability thereof. However, when content contained in the container is partially discharged and part of the content remains, the container tends to slant towards one side. When a container that contains detergents slants toward one side, various problems are generated. To solve theses problems, a reinforcing portion is attached to a side portion of the container, preventing the container from falling to one side.

Japanese patent No. 10-323849 discloses a container with an improved self-supporting ability. However, the above container cannot be manufactured with a standard back sealer.

U.S. Pat. No. 6,092,933 discloses a container with an improved self-supporting property, wherein the container is manufactured with four different films stated as front film, rear film, upper wedge and lower wedge. Thus films structure is more weekly in terms of container strength which imply that the films should be considerately thick as to achieve stability.

### SUMMARY OF THE INVENTION

A collapsible liquid container. According to an embodiment of the invention the collapsible container may include: (i) a first sheet that includes a cover wedge portion that forms a collapsible cover of the collapsible liquid container; a bottom wedge portion that forms a collapsible bottom of the collapsible liquid container; and a sheet body that forms a first side wall of the collapsible liquid container; wherein the cover wedge portion and the bottom wedge portion are integral extensions of the sheet body; and (ii) a second sheet that forms a second side wall of the collapsible liquid container.

A method for making foldable liquid containers. According to an embodiment of the invention the method for making foldable liquid containers may include: placing a first film above a second film; double folding the first film, along both longitudinal edges of the first film, as to create two longitudinal wedges; creating latitudinal welding lines which are stretched between the two longitudinal edges of the films and wherein the latitudinal welding lines are substantially perpendicular to the longitudinal edges; creating longitudinal welding segments along a second longitudinal edge of the films; and cutting off, cutting lines across a middle of the latitudinal welding lines.

A collapsible liquid container. According to an embodiment of the invention the collapsible container may include: (i) a first sheet, comprising: a cover wedge portion that forms a collapsible cover of the collapsible liquid container; and a first sheet body that forms a first side wall of the collapsible liquid container; wherein the cover wedge portion is integral extension of the first sheet body; and (ii) a second sheet, comprising: a bottom wedge portion that forms a collapsible bottom of the collapsible liquid container; and a second sheet body that forms a second side wall of the collapsible liquid container; wherein the bottom wedge portion is integral extension of the second sheet body.

A method for making foldable liquid containers. According to an embodiment of the invention the method for making foldable liquid containers may include: (i) placing a first film above a second film; (ii) double folding a first longitudinal edge of the first film, as to create a first longitudinal wedge and double folding a second opposite longitudinal edge of the second film, as to create a second longitudinal wedge; (iii) creating latitudinal welding lines which are stretched between the two longitudinal edges of the first film and wherein the latitudinal welding lines are substantially perpendicular to the longitudinal edges; (iv) creating longitudinal welding segments along a second longitudinal edge of the first film; and (v) cutting off, cutting lines along the middle of the latitudinal welding lines.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a perspective view of a first film of a collapsible liquid container according to an embodiment of the invention;

FIG. 2 is a perspective view of the first film and a second film of the collapsible liquid container according to an embodiment of the invention;

FIG. 3 is a block diagram that illustrates the various parts of the first film and the second film of the collapsible liquid container according to an embodiment of the invention;

FIGS. 4A and 4B are perspective views of collapsible liquid containers according to an embodiment of the invention;

FIGS. 4C and 4D are schematic side views of collapsible liquid containers according to an embodiment of the invention;

FIG. 4E is a rear view of collapsible liquid containers according to an embodiment of the invention;

FIGS. 5, 6A, 6B, 6C, 7A, 7B and 8 are perspective views of a production line for producing collapsible liquid containers, according to an embodiment of the invention; and

FIG. 8 illustrates a flow diagram of a method for making the collapsible liquid containers, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A collapsible liquid container 10 is provided. When collapsible liquid container 10 is empty it can be folded into a compact size. When filling up collapsible liquid container 10, with any soft content, such as liquid, a collapsible bottom and a collapsible cover of collapsible liquid container 10 expand, thus collapsible liquid container 10 gains stability and maintain a self-supporting state. The expansion ability, as well as the collapsing ability of the collapsible bottom and the collapsible cover of collapsible liquid container 10 is achieved due to wedge portions that form the bottom and collapsible covers.

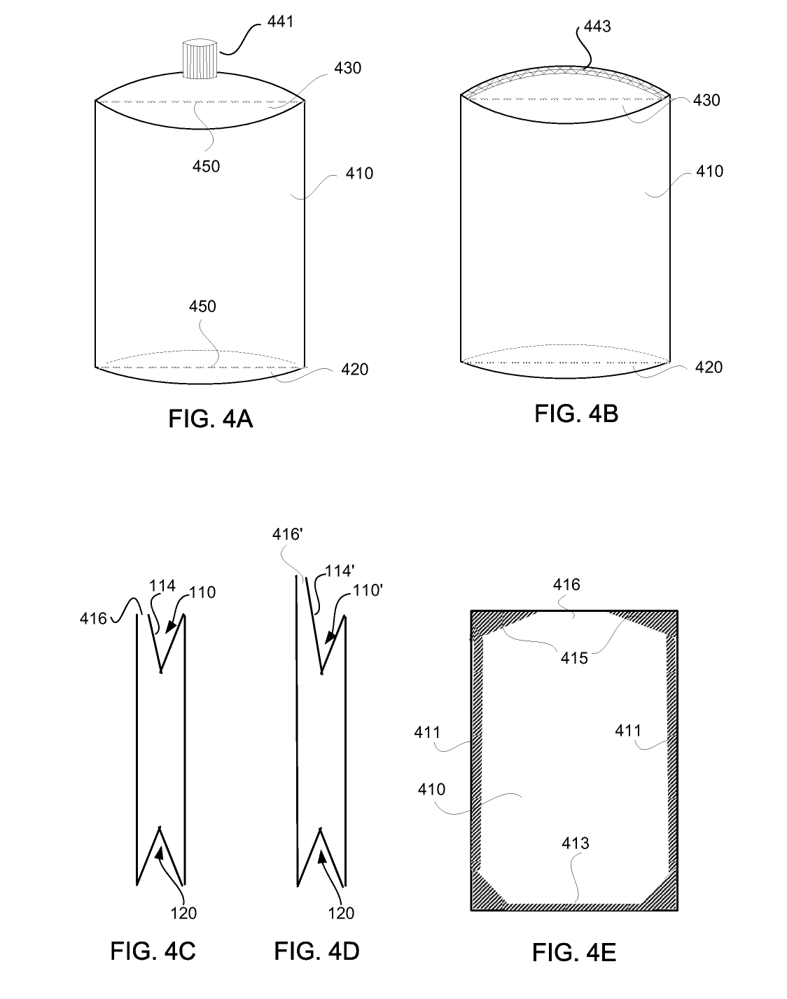

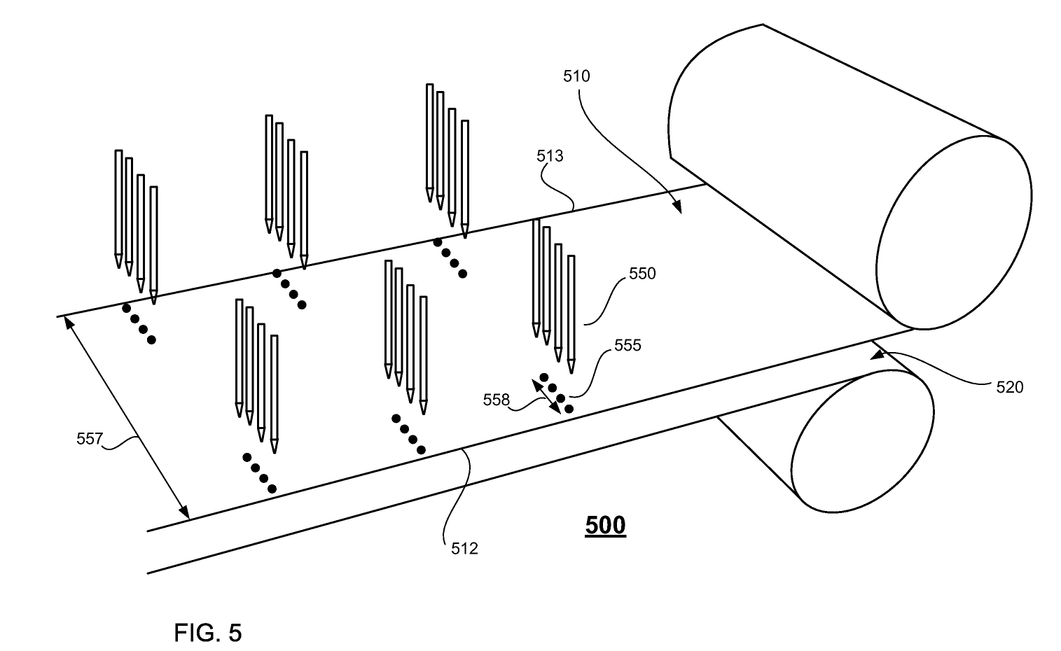

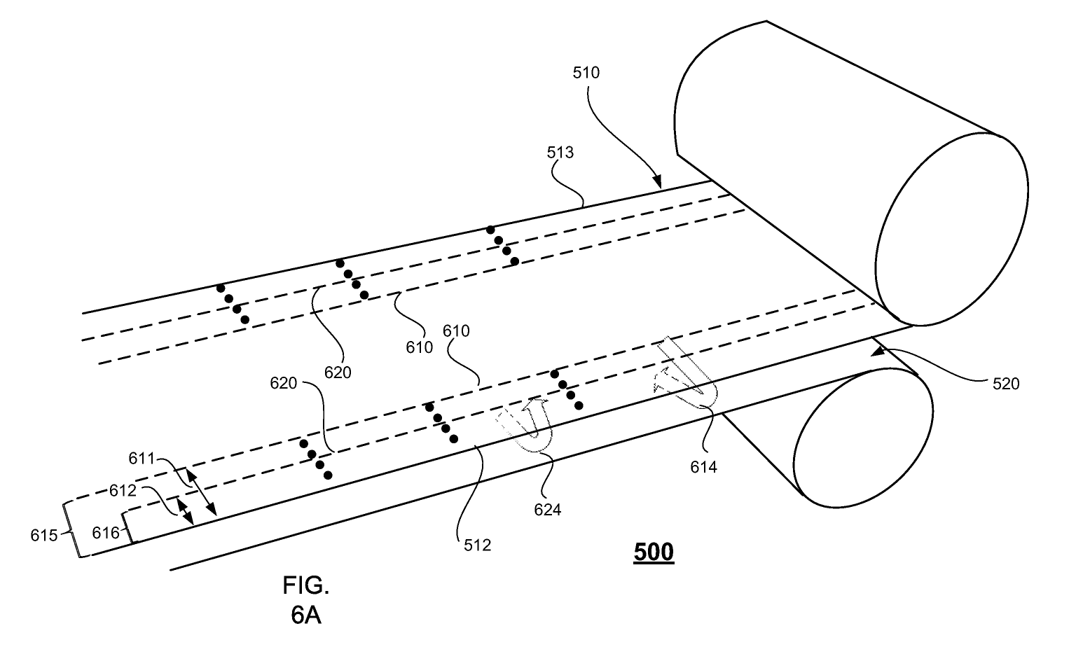

The expanded state of collapsible liquid container 10, that is obtained when it is filled up with content, is illustrated in FIG. 4A and FIG. 4B. The collapsed state of collapsible liquid container 10, that is obtained when collapsible liquid container 10 is emptied, is illustrated in FIGS. 4C-4E. FIG. 4E is a rear view of the collapsed collapsible liquid container 10, wherein FIGS. 4C and 4D are side views of a partially collapsed collapsible liquid container 10. Note the wedge potions, with a V-like shape, at the bottom and collapsible covers of collapsible liquid container 10, due to which collapsible liquid container 10 gains its expansion and collapsing abilities.

Collapsible liquid container 10 is built of 2 sheets only, wherein the wedge portion at the bottom part and the wedge portion at the cover part are integral parts of one of the two sheets that forms collapsible liquid container 10. An upper part of the first sheet forms a cover wedge portion, that forms the cover part of collapsible liquid container 10 and a lower side of the first sheet or of the second sheet forms a bottom wedge portion that forms the bottom part of collapsible liquid container 10.

Using only two sheets for making collapsible liquid container 10, eliminates the number of welding lines that are required for connecting the sheets. Thus only 3 or 4 welding lines are required for making collapsible liquid container 10. Eliminating the amount of welding lines results in a stronger and durable container.

A production line of collapsible liquid container 10 includes two films, placed one above the other, as shown in FIG. 5. A first film, which is placed above a second film, is double folded on one of its longitudinal edges as to form the wedge portion for a collapsible cover of collapsible liquid container 10. A second longitudinal edge of the first film or a longitudinal edge of the second film, is double folded, as to form the wedge portion for a collapsible bottom of collapsible liquid container 10.

Mass production is possible by utilizing series of mechanical automation processes. Due to the simple manner of the production, the automation can be achieved by using existing equipment.

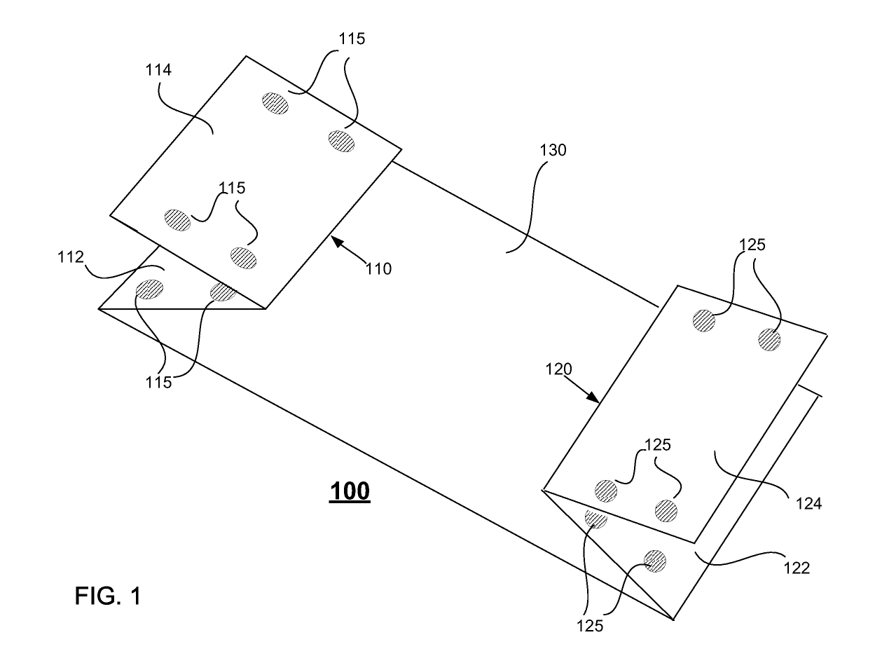

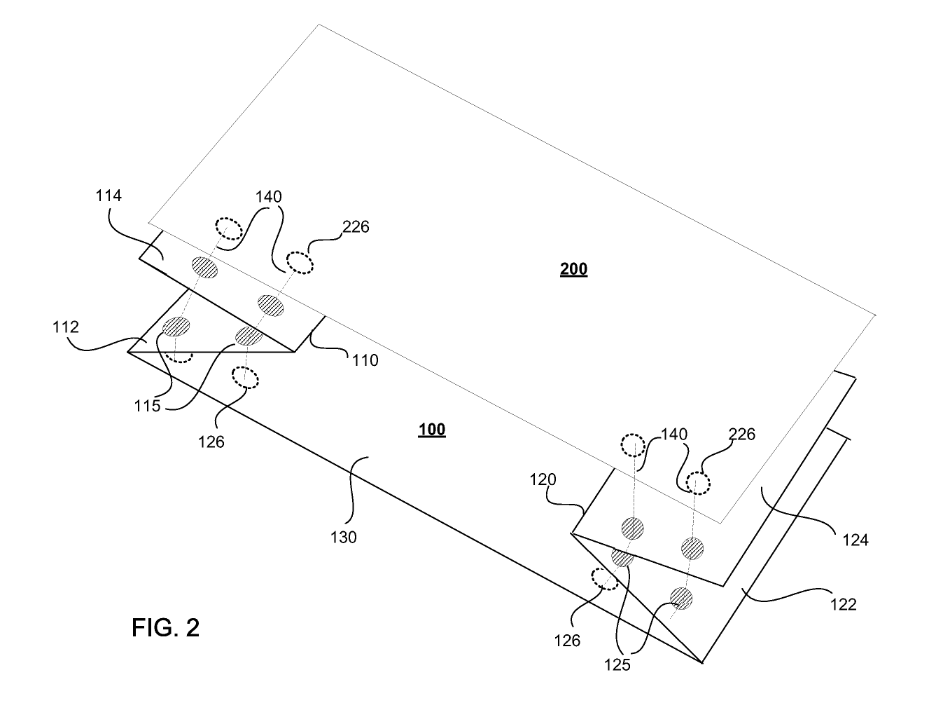

FIG. 1 illustrates a first sheet 100 before being attached to a second sheet 200 (FIG. 2). Note that first sheet 100 and a second sheet 200 are part of a first film and a second film that are described in FIGS. 5-8. Note that sheets 100 and 200 do not really exist in the separated form that is illustrated in FIGS. 1-3 and the separation is used for explanatory purposes only.

First sheet 100 includes: (i) a sheet body 130 which is the middle part of first sheet 100 and will form a first side wall of collapsible liquid container 10; (ii) a cover wedge portion 110 that will form a collapsible cover of collapsible liquid container 10; and (iii) a bottom wedge portion 120 that will form a collapsible bottom of collapsible liquid container 10.

Note that cover wedge portion 110 and the bottom wedge portion 120 are integral extensions of sheet body 130.

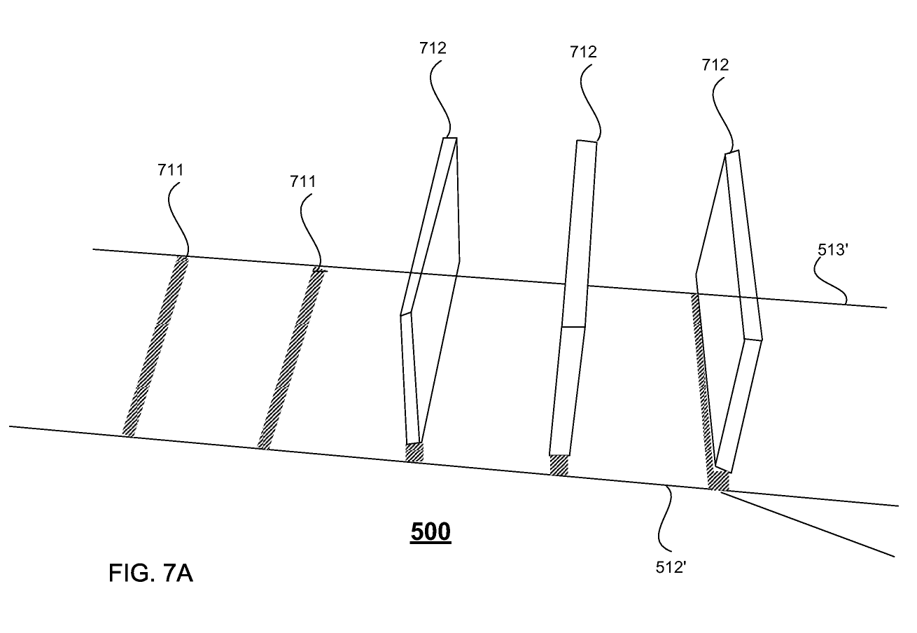

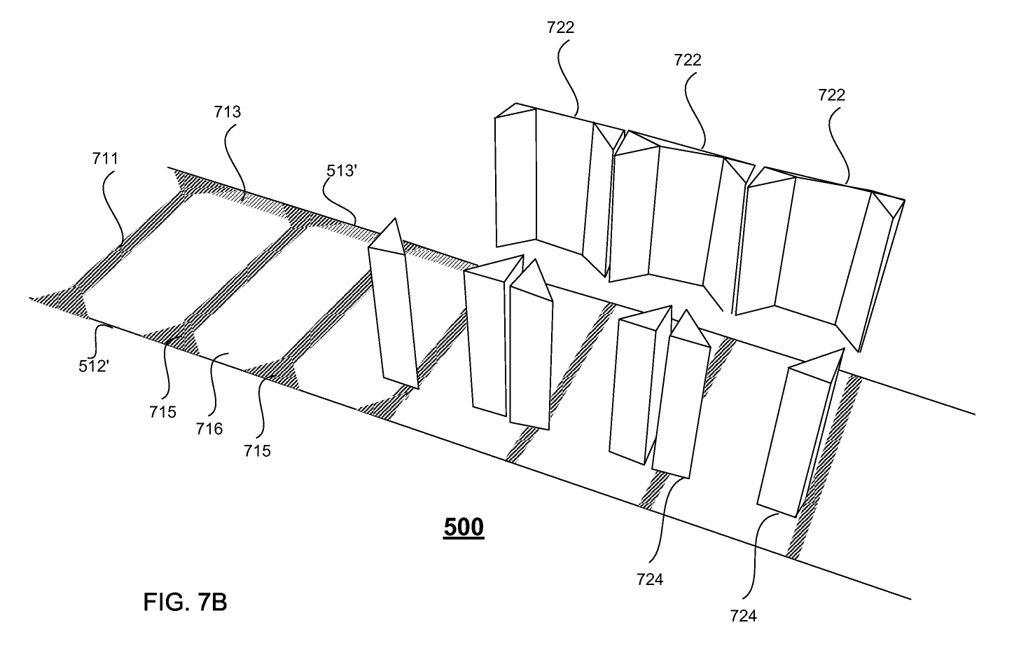

Cover wedge portion 110 includes: (i) a first cover fold strip 112; (ii) a second cover fold strip 114; and (iii) cover wedge portion's holes 115 that will be used in the sealing process, described in FIGS. 7A and 7B. Second cover fold strip 114 is either the same size as first cover fold strip 112 (as illustrated in FIG. 1) or second cover fold strip 114 can be extended along a longitudinal axis of first sheet 100 and be longer than first cover fold strip 112 (as can be seen in FIG. 4D). Bottom wedge portion 120 is similar to cover wedge portion 110 and includes: (i) a first bottom fold strip 122; (ii) a second bottom fold strip 124; and (iii) bottom wedge portion's holes 125. First bottom fold strip 122 is of the same size as second bottom fold strip 124.

FIG. 2 illustrates the position of a second sheet 200 in relation to first sheet 100. Second sheet 200 overlaps first sheet 100, along with its cover and bottom wedges portions 110 and 120, when the wedges portions are fully folded. I.e. second sheet 200, when attached to first sheet 100 will overlap: (i) second cover fold strip 114 of cover wedge portion 110; (ii) second bottom fold strip 124 of bottom wedge portion 120; and (iii) a middle part of sheet body 130 which excludes the two wedge portions' areas.

Imaginary dashed lines 140 demonstrate contact points of first sheet 100 and second sheet 200 when overlaps each other, wherein the two cover fold strips of cover wedge portion 110 interpose between the two sheets. The same interposing exists for the lower side of the two sheets. When first sheet 100 is attached to sheet 200, imaginary spots 126 of first sheet 100 gain a direct contact with imaginary spots 226 of second sheet 200, through holes 115 and 125 of cover wedge portion 110 and bottom wedge portion 120, respectively. This direct contact of the two sheets is essential for the fusing process, so as to seal the side edges of the upper part and lower part of the two sheets, even though the wedges portion are interposed.

Although FIG. 1-FIG. 3 illustrate four holes on each side of sheet 100, this is not necessarily so and any other even number of holes can be implemented. Further more, the shape of the holes is not limited to circles and non limiting examples of holes shapes include circles, half circles, ellipse, square, triangle, rectangle, and the like.

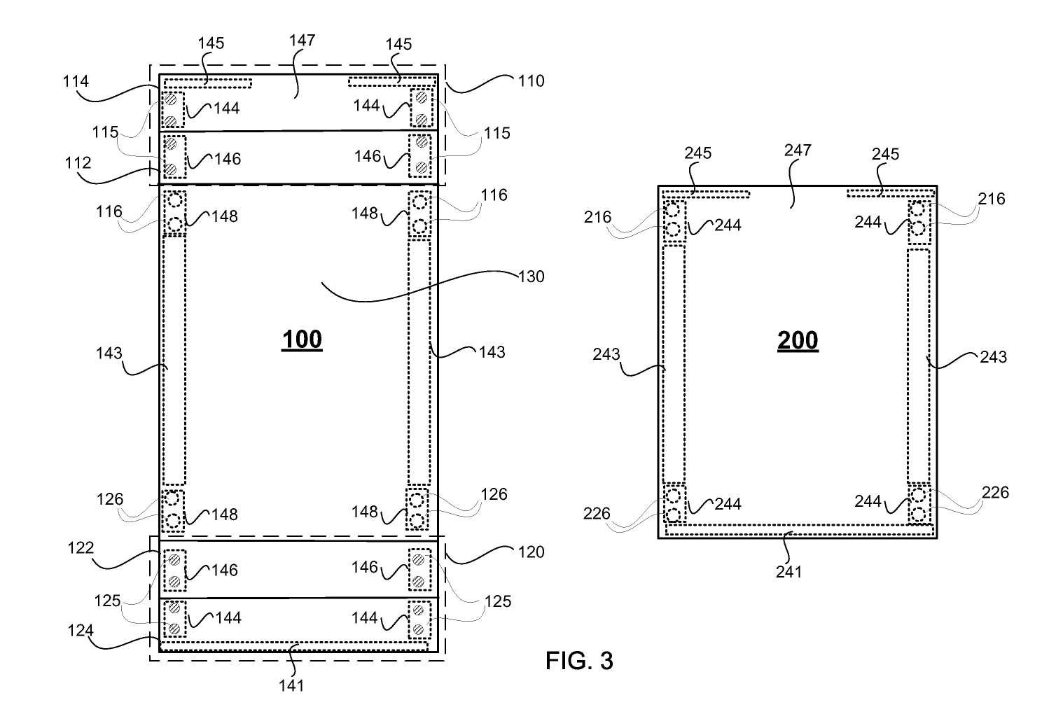

FIG. 3 illustrates a spread state of first sheet 100 and second sheet 200, so as to map the different parts of the sheets, and especially—the areas that will be sealed. The areas to be sealed are illustrated as dotted lines.

At least three edges, out of four edges, of first sheet 100 are welded to the corresponding three edges of second sheet 200, so as to provide a content receiving space of collapsible liquid container 10. The three sealed edges are illustrated in FIG. 4E: bottom welding line 413 along a marginal edge of a collapsible bottom of collapsible liquid container 10 and two side welding lines 411 along the longitudinal edges of the two side walls.

A fourth edge of first sheet 100 and second sheet 200 is optionally partially welded, as illustrated in FIG. 4E, by top welding areas 415 at an outer edge of the collapsible cover of collapsible liquid container 10, excluding an unsealed area 416, also referred to as opening 416. According to another embodiment of the invention, the fourth edge of first sheet 100 and second sheet 200 is fully welded, in which case the collapsible cover is fully sealed and opening 416 doesn't exist (but can be created later by cutting-off). According to a third embodiment, the fourth edge of first sheet 100 and second sheet 200 is not welded at all, so that the collapsible cover is unsealed, resulting a full opening of the collapsible cover.

Referring back to FIG. 3, a second bottom area 241 of second sheet 200 is welded to a first bottom area 141 of first sheet 100, providing a bottom welding line 413 (FIG. 4E). First bottom area 141 resides at the free bottom edge of second bottom fold strip 124.

A second top area 245 of second sheet 200 is welded to a first top area 145 of first sheet 100, to provide a cover welding area 415 (FIG. 4E). First top area 145 resides at the top edge of second cover fold strip 114.

Note that according to an embodiment of the invention, each of first top area 145 and second top area 245 can be contiguous areas, along all the top edge of second cover fold strip 114 and second sheet 200, respectively.

According to another embodiment of the invention, each of first top area 145 and second top area 245 can be split into two smaller separated areas as illustrated in FIG. 3, in which case unsealed areas 147 and 247 remain between the split areas. Note that according to another embodiment of the invention first top area 145 and second top area are not sealed at all, thus, the top area of collapsible liquid container 100 remains opened.

First side areas 143 of first sheet 100 will be welded to second side areas 243 of second sheet 200. First and second side areas, 143 and 243, are a middle part of the longitudinal edges of the sheets.

Areas 148 of first sheet 100, excluding spots 116 and 126, will be welded to corresponding areas 146 of first sheet 100, that resides on first fold strips 112 and 122.

Areas 244 of second sheet 200, excluding spots 216 and 226, will be welded to corresponding areas 144 of first sheet 100, that resides on second fold strips 114 and 124.

Second bottom spots 226 of second sheet 200 will be welded to first bottom spots 126 of first sheet 100. The direct contact between second bottom spots 226 and first bottom spots 126 is achieved thanks to holes 125 of bottom wedge portion 120.

Second top spots 216 of second sheet 200 will be welded to first top spots 116 of first sheet 100. The direct contact between second top spots 216 and first top spots 116 is achieved thanks to holes 115 of cover wedge portion 110.

The welding of areas 143 and 144, of sheet 100, to the corresponding areas 243 and 244 of second sheet 200, combined with the welding of areas 146 to areas 148 of first sheet 100, combined with the welding of spots 116 of first sheet 100 to spots 216 of second sheet 200—all together provides side welding lines 411 of FIG. 4E.

FIG. 4A-4E illustrate the collapsible liquid container after manufacturing thereof.

FIGS. 4A and 4B illustrate two embodiments of collapsible liquid container 10 in an expanded state thereof, when filled with content. A rear side wall (not shown) of collapsible liquid container 10 is made of sheet 200 and a front side wall 410 is made of sheet body 130 of sheet 100. A collapsible bottom 420 of collapsible liquid container 10 is made of bottom wedge portion 120 (FIG. 1). A collapsible cover 430 of collapsible liquid container 10 is made of cover wedge portion 110.

Fold lines 450 that traverse collapsible cover 430 and collapsible bottom 420, are indicated by dashed lines. Fold lines 415 are the borders between first fold strips, 112 and 122 at the cover, and second fold strip, 114 and 124 at the bottom, respectively. Fold lines 415 provide the expanding and collapsing ability of collapsible liquid container 10.

Opening 416 (FIG. 4E) of collapsible liquid container 10, which was formed by unsealed area 147 of first sheet 100 that overlaps unsealed area 247 of second sheet 100, can be fitted with a discharge element for configuring a main exit of contents.

Collapsible liquid container 10 of FIG. 4A illustrates a partially welded top that is fitted with a discharge element, such as a cork 441. The discharge element can be disposed at opening 416.

FIG. 4B illustrates collapsible liquid container 10 that was fitted with a zipper 443. FIG. 4B illustrates a non-welded top, so opening 416, in which zipper 443 is disposed, is all along the rear edge of collapsible cover 430.

FIG. 4C is a side view of a collapsed collapsible liquid container 10, wherein bottom wedge portion 120 at the bottom and cover wedge portion 110 are noticeable, having a sharp V-shape.

FIG. 4D is a side view of a collapsed collapsible liquid container 10, according to another embodiment of the invention, wherein cover wedge portion 110′ is asymmetric, because second cover fold strip 114′ is extended and thus opening 416′ is higher than opening 416 of FIG. 4C.

FIG. 4E is a rear view of collapsible liquid container 10 and illustrates the welding lines, as was previously set forth. The difference between the rear view and a front view, is that bottom welding line 413 and cover welding line 415 can only be seen from the rear side.

The next figures illustrate various stages in a production line 500 for a mass production of collapsible liquid containers 10.

FIG. 5 illustrates a first stage of the production. A first film 510 is placed above a second film 520. First film 510 is utilized for creating multiple first sheets 100 of collapsible liquid containers 10 and second film 520 is utilized for creating multiple second sheets 200.

Although the following description relates to an embodiment that uses first film 510 for the creation of both cover wedge portion 110 and bottom wedge portion 120, it should be noted that according to another embodiment of the invention, first film 510 is utilizes for the creation of cover wedge portion 110 and second film 520 is utilizes for the creation of bottom wedge portion 120. According to the first embodiment, first film 510 may be wider than second film 520 and according to the latter embodiment, first film 510 may have the same width as second film 520.

Puncturers 550 create hole lines 555, ascending from both longitudinal edges 512 and 513 of first film 510. Each hole line 555 is formed in a row that is substantially perpendicular to longitudinal edges 512 and 513. A first hole out of hole line 555 is considerably close to longitudinal edges 512 or 513 and the length of hole line 555, illustrated by an arrow 558, is considerably smaller than a width 557 of first film 510.

The distance between each hole line 555 to the adjacent hole line 555 is substantially equal to a width of side walls 410 of collapsible liquid container 10, and hole lines 555 will eventually become holes 115 and holes 125 of cover wedge portion 110 and bottom wedge portion 120.

Although FIG. 5 illustrates hole lines 555 as having four holes in each hole line, this is not necessarily so and hole lines 555 can have any other even number of holes. Further more, the shape of the holes is not limited to circles and non limiting examples of holes shapes include circles, ellipse, square, triangle, rectangle, and the like.

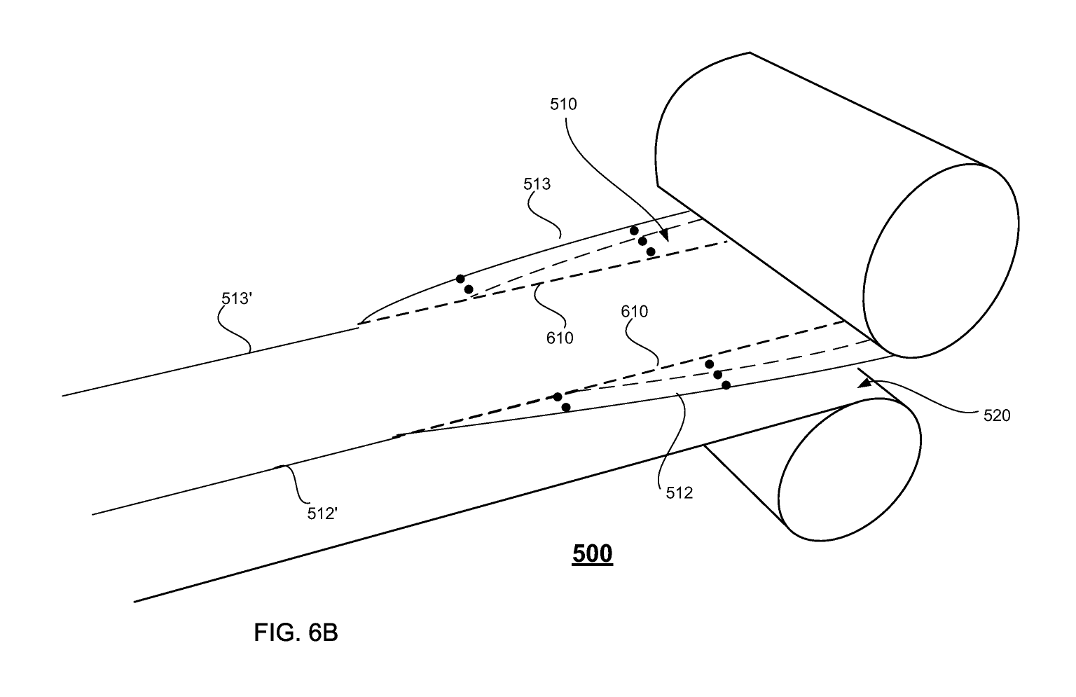

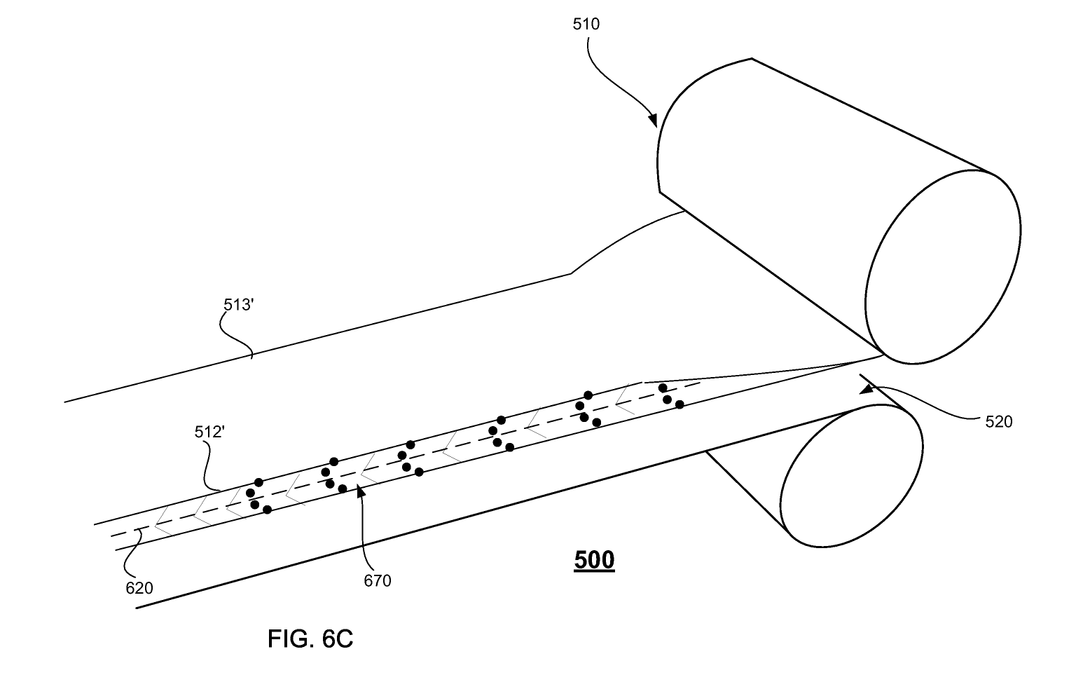

FIGS. 6A, 6B and 6C illustrate the next stage of production, in which first film 510 is double folded as to create a longitudinal wedge on both longitudinal edges of first film 510. Note that according to another embodiment of the invention, a longitudinal wedge is formed on one longitudinal edge of first film 510 and another longitudinal wedge is formed on the opposite longitudinal edge of second film 520.

Referring now to FIG. 6A, two first longitudinal fold strips 615 are formed along both longitudinal edges 512 and 513 of first film 510. First folding axes 610 are indicated by two dashed lined, one is closer to longitudinal edge 512 and the other is closer to longitudinal edge 513. First folding axes 610 indicate the axes around which longitudinal edges 512 and 513 are rotated in order to form two first longitudinal fold strips 615. The longitudinal borders of each first longitudinal fold strip 615 are the first folding axis 610 from one side and longitudinal edges 512 or 513, from the other side. A width 611 of the two first longitudinal fold strips 615, between each longitudinal edge 512 or 513 and the corresponding first folding axis 610, is wide enough as to include all hole lines 555.

First longitudinal folds 615 are formed by folding longitudinal edges 512 and 513, around first folding axes 610, downwards and towards the center of first film 510, as indicated by arrow 614.

FIG. 6B illustrates first film 510 after being folded once. It can be seen that the old longitudinal edges 512 and 513 are disappearing under first film 510 and first folding axes 610 become the new longitudinal edges 512′ and 513′ of first film 510.

Referring back to FIG. 6A, two second folding axes 620, indicated by two dashed lines, are the axes around which longitudinal edges 512 and 513 (that at this stage lie under first film 510) are rotated in order to form two second longitudinal fold strips 616.

The two second longitudinal fold strips 616 are formed by folding longitudinal edges 512 and 513 (that at this stage lie under first film 510) on the other direction (downwards and away from the center of first film 510) around the two second folding axes 620.

According to one embodiment of the invention, a width 612 of second longitudinal fold strip 616 that is closer to longitudinal edges 512, is approximately half of a width 611 of first longitudinal fold strip 165 and it includes half of the holes in each hole line 555. E.g. if the original hole line 555 included 4 holes, then now each of the two longitudinal fold strips 615 and 616 include two holes from each hole line.

According to another embodiment, width 612 of second longitudinal fold strip 616, is larger than half the width 611 of first longitudinal fold strip 615, thus forming asymmetric wedge, as illustrated in FIG. 4D.

FIG. 6C illustrates first film 510 after being folded twice. Lines 512′ and 513′ still indicate the new longitudinal edges of first film 100. Dashed line 620 indicates the second folding axis.

The double folding, described above, forms a longitudinal wedge 670 along both longitudinal edges 512 and 513 of first film 100. The two longitudinal wedges 670 will form cover wedge portion 110 and bottom wedge portion 120 of collapsible liquid container 10.

Although the sequence of the folding, required to form longitudinal wedge 670, was specified above, it would be obvious to those skilled in the art that longitudinal wedge 670 can be formed by using other sequences as well. For example: a first fold can be created by rotating longitudinal edges 512 and 513 around folding axes 620, wherein the rotating is upwards and towards the center of first film 510. A second fold can be created by rotating the first fold, around folding axes 610, downwards and towards the center of first film 510.

FIGS. 7A and 7B illustrates the production line 500, in the stage of sealing. The sealing is done by using heat deflection, heat adhesion or any other method known in the art.

FIG. 7A illustrates three first sealers 712 that seal first film 510 to second film 520 and creates latitudinal welding lines 711, wherein latitudinal welding lines 711 are stretched between both longitudinal edges 512′ and 513′ of first film 510 and wherein latitudinal welding lines 711 are substantially perpendicular to both longitudinal edges 512′ and 513′ of first film 510. Latitudinal welding lines 711 will form the two side welding lines 411 of collapsible liquid container 10 illustrated in FIG. 4E.

Although FIG. 7A illustrates three first sealers 712, any other number of first sealers 712 can be implemented.

FIG. 7B illustrates three second sealers 722 and three third sealers 724. Second sealers 722 seal first film 510 to second film 520 and creates longitudinal welding segments 713, wherein longitudinal welding segments 713 are stretched along longitudinal edge 513′ and wherein each longitudinal welding segment 713 is stretched from one latitudinal welding line 711 to an adjacent latitudinal welding line 711.

Longitudinal welding segments 713 are illustrated in lighter lines as they can only be seen from the rear side of second film 200.

Longitudinal welding segments 713 are the same as welding line 413 of collapsible liquid container 10 that is illustrated in FIG. 4E.

Although FIG. 7B illustrates three second sealers 722, any other number of second sealers 722 can be implemented.

Three third sealers 724 seal first film 510 to second film 520 and creates welding areas 715, wherein welding areas 715 are stretched along part of longitudinal edge 512′, perpendicular and adjacent to latitudinal welding line 711.

Third sealers 724 leave an unsealed area 716 that will form the opening 416 at the cover 430 of collapsible liquid container 10.

Although FIG. 7B illustrates three third sealers 724, any other number of third sealers 724 can be implemented.

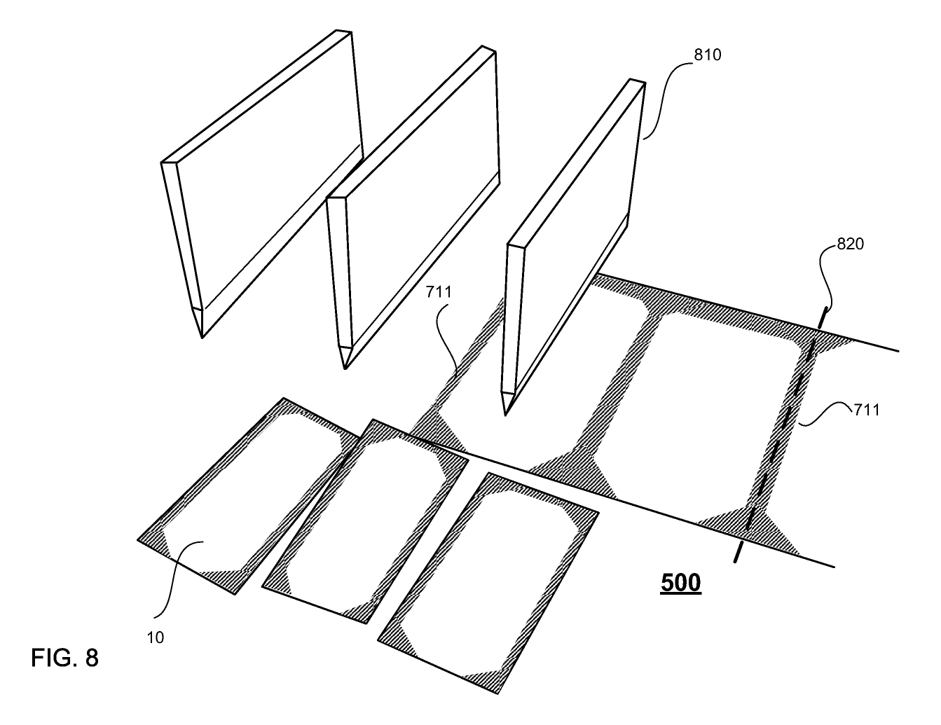

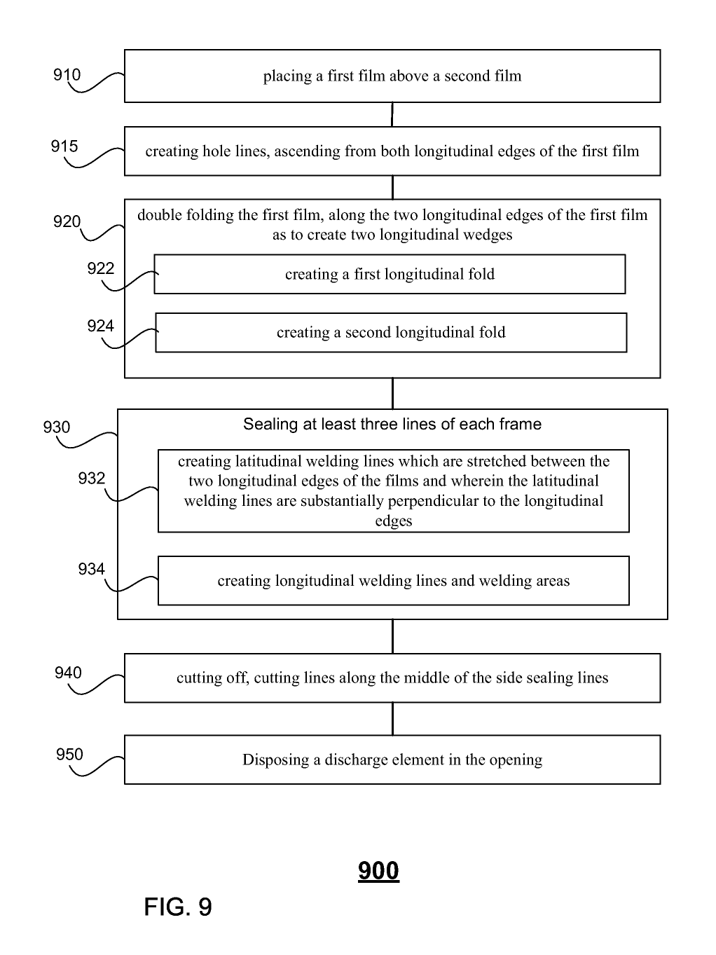

FIG. 8 is the last stage of manufacturing that illustrates the cutting-off the sealed film 510 and film 520, by cutters 810. The cutting-off lines are made along the middle 820 of side welding lines 411. After this stage multiple collapsible liquid container 10 are ready to be filled with content.

FIG. 9 is a flow diagram of method 900 for manufacturing of collapsible liquid container 10.

Method 900 begins with stage 910 of placing a first film above a second film.

Stage 910 is followed by stage 915 of creating hole lines, ascending from both longitudinal edges of first film 510. Each hole line is formed in a row that is substantially perpendicular to both longitudinal edges.

Stage 915 is followed by stage 920 of double folding the first film, along the two longitudinal edges of the first film as to create two longitudinal wedges.

Stage 920 includes two stages: stage 922 for creating a first longitudinal fold strip, followed by stage 924 of creating a second longitudinal fold strip.

Stage 922 can create the first longitudinal fold strip by folding longitudinal edges of the first film, around first folding axes, downwards and towards the center of first film. In this case the first longitudinal fold strip includes all the holes of the hole line and the first longitudinal fold strip lies beneath the first film.

Stage 924 can create the second longitudinal fold by folding part the width of the first longitudinal strips (that at this stage lie beneath first film 510), downwards and away from the center of the first film and around the two second folding axes.

Alternately, stage 922 can create the first longitudinal fold strip by rotating the longitudinal edges around the second folding axes, wherein the rotating is upwards and towards the center of the first film. In this case, stage 924 can create the second longitudinal fold strip by rotating the first longitudinal fold strip, around the first folding axes, downwards and towards the center of the first film.

Stage 920 is followed by stage 930 of sealing at least three edges of the collapsible liquid container. The sealing is done by using heat deflection, heat adhesion or any other method known in the art.

Conveniently, stage 430 can include two stages of sealing: stage 432 and stage 434. Stage 432 of creating latitudinal welding lines which are stretched between the two longitudinal edges of the films and wherein the latitudinal welding lines are substantially perpendicular to the longitudinal edges.

Stage 434 of creating longitudinal welding segments along a second longitudinal edge of the films and welding areas along a first longitudinal edge. The longitudinal welding segments fully seal the second longitudinal edge while the welding areas partially seals the first longitudinal edge or fully seals he first longitudinal edge. Unsealed areas remain in the middle of the line between the latitudinal welding lines. According to another embodiment of the invention the first longitudinal edge is fully sealed and according to yet another embodiment of the invention the first longitudinal edge is not sealed at all.

Stage 930 is followed by stage 940 of cutting off cutting lines that pass along the middle of the latitudinal welding lines.

Optionally, stage 940 is followed by stage 950 of disposing a discharge element in the opening. The discharge element can be a cork, a zipper, a spout or any other discharge element known in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A collapsible liquid container, comprising:
a first sheet, comprising: a cover wedge portion that forms a collapsible cover of the collapsible liquid container; a bottom wedge portion that forms a collapsible bottom of the collapsible liquid container; and a sheet body that forms a first side wall of the collapsible liquid container; wherein the cover wedge portion and the bottom wedge portion are integral extensions of the sheet body; and
a second sheet that forms a second side wall of the collapsible liquid container.

2. The collapsible liquid container according to claim 1, comprising a bottom welding line and two side welding lines, wherein the bottom welding line seals a free edge of the bottom wedge portion to a bottom edge of the second sheet and wherein the two side welding lines seals two longitudinal edges of the first sheet to two longitudinal edges of the second sheet, to provide a content receiving space of the collapsible liquid container.

3. The collapsible liquid container according to claim 1, wherein a free edge of the cover wedge portion overlaps a top edge of the second sheet without being sealed, so as to form an opening.

4. The collapsible liquid container according to claim 1, comprising a cover welding area that seals at least part of a free edge of the cover wedge portion to at least a part of an upper edge of the second sheet.

5. The collapsible liquid container according to claim 3, further comprising a discharge element that is disposed in the opening.

6. The collapsible liquid container according to claim 1, wherein the cover wedge portion comprising: a first cover fold strip, a second cover fold strip and a fold line between the first cover fold strip and the second cover fold strip; wherein the collapsible cover of collapsible liquid container can be folded along the fold line.

7. The collapsible liquid container according to claim 1, wherein the bottom wedge portion comprising: a first bottom fold strip; a second bottom fold strip of the same size as the first bottom fold strip; and a fold line between the first bottom fold strip and the second bottom fold strip;
wherein the collapsible bottom of the collapsible liquid container can be folded along the fold line.

8. The collapsible liquid container according to claim 6, wherein the second cover fold strip has the same size as the first cover fold strip.

9. The collapsible liquid container according to claim 6, wherein the second cover fold strip is extended along a longitudinal axis of the first sheet, so that it is longer than the first cover fold strip.

10. A method for making foldable liquid containers, comprising:
placing a first film above a second film;
double folding the first film, along both longitudinal edges of the first film, as to create two longitudinal wedges;
creating latitudinal welding lines which are stretched between the two longitudinal edges of the films and wherein the latitudinal welding lines are substantially perpendicular to the longitudinal edges;
creating longitudinal welding segments along a second longitudinal edge of the films; and
cutting off, cutting lines across a middle of the latitudinal welding lines.

11. The method of claim 10, wherein the double folding comprises: creating a first longitudinal fold along both longitudinal edges of the first film and creating second longitudinal fold by folding back part of the first longitudinal fold.

12. The method of claim 10 further comprising creating hole lines, ascending from both longitudinal edges of the films and wherein the hole lines are substantially perpendicular to the longitudinal edges.

13. The method of claim 10 further comprising creating welding areas along a first longitudinal edge of the films, wherein an area between two adjacent welding areas remains unsealed.

14. A collapsible liquid container, comprising:
a first sheet, comprising: a cover wedge portion that forms a collapsible cover of the collapsible liquid container; and a first sheet body that forms a first side wall of the collapsible liquid container; wherein the cover wedge portion is integral extension of the first sheet body; and
a second sheet, comprising: a bottom wedge portion that forms a collapsible bottom of the collapsible liquid container; and a second sheet body that forms a second side wall of the collapsible liquid container; wherein the bottom wedge portion is integral extension of the second sheet body.

15. The collapsible liquid container according to claim 14, comprising a bottom welding line and two side welding lines, wherein the bottom welding line seals a free edge of the bottom wedge portion to a bottom edge of the first sheet and the two side welding lines seals two longitudinal edges of the first sheet to two longitudinal edges of the second sheet, to provide a content receiving space of the collapsible liquid container.

16. A method for making foldable liquid containers, comprising:
placing a first film above a second film;
double folding a first longitudinal edge of the first film, as to create a first longitudinal wedge and double folding a second opposite longitudinal edge of the second film, as to create a second longitudinal wedge;
creating latitudinal welding lines which are stretched between the two longitudinal edges of the first film and wherein the latitudinal welding lines are substantially perpendicular to the longitudinal edges;
creating longitudinal welding segments along a second longitudinal edge of the first film; and
cutting off, cutting lines along the middle of the latitudinal welding lines.

17. The method of claim 16, wherein the double folding comprises: creating a first longitudinal fold along the first longitudinal edge of the first film, creating a second longitudinal fold along the second opposite longitudinal edge of the second film, creating a third longitudinal fold by folding back part of the first longitudinal fold and creating a fourth longitudinal fold by folding back part of the second longitudinal fold.
